(19) United States
(12) Patent Application Publication
(10) Pub. No.: US 2024/0249053 A1
(43) Pub. Date: Jul. 25, 2024

(54) TIMING ANALYSIS IN STACKED DIES

(71) Applicant: Synopsys, Inc., Mountain View, CA (US)

(72) Inventors: Subramanyam SRIPADA, Portland, OR (US); Krishnakumar SUNDARESAN, Dublin, CA (US); Peivand TEHRANI, Campbell, CA (US)

(21) Appl. No.: 18/101,098

(22) Filed: Jan. 24, 2023

(51) Int. Cl. G06F 30/3315; G06F 30/337

(52) U.S. Cl. CPC G06F 30/3315; G06F 30/337

(57) ABSTRACT

Systems and methods for analyzing circuit designs are presented. A method includes receiving a circuit design comprising a first die and a second die positioned on the first die and generating, by a processing device, a first virtual interface block comprising a portion of the first die and a first virtual die positioned adjacent to the first die. A layer of the first virtual die closest to the first die includes first tracks filled with virtual metal. The method also includes performing parasitic extraction based at least in part on the first virtual interface block to generate a first model of inter-die coupling between the first die and the first virtual die.

### TECHNICAL FIELD

The present disclosure relates to electric circuit design, such as integrated circuit design. More specifically, the present disclosure relates to parasitic extraction and timing analysis in electric circuits with stacked dies.

### BACKGROUND

During electric circuit design, timing analysis is performed to determine delays in different paths of an electric circuit. The delays may be affected by various factors of the circuit, such as parasitics (e.g., parasitic resistances and parasitic capacitances) present in the circuit. Generally, it may be desirable to adjust the circuit design to delays, especially if the delays are too large and cause the circuit to function improperly.

### SUMMARY

Systems and methods for analyzing circuit designs are presented. According to an embodiment, a method includes receiving a circuit design comprising a first die and a second die positioned on the first die and generating, by a processing device, a first virtual interface block comprising a portion of the first die and a first virtual die positioned adjacent to the first die. A layer of the first virtual die closest to the first die includes first tracks filled with virtual metal. The method also includes performing parasitic extraction based at least in part on the first virtual interface block to generate a first model of inter-die coupling between the first die and the first virtual die.

The method may include generating a second virtual interface block including a portion of the second die and a second virtual die. A layer of the second virtual die closest to the second die may include second tracks filled with virtual metal. The method may include performing parasitic extraction based at least in part on the second virtual interface block to generate a second model of inter-die coupling between the second die and the second virtual die. The method may include performing static timing analysis for the second die using the second model of inter-die coupling between the second die and the second virtual die.

The portion of the first die may include one or more of a first layer, a second layer positioned on the first layer, and a third layer positioned on the second layer.

Performing parasitic extraction based at least in part on the first virtual interface block may include generating coupling capacitors from the portion of the first die to the first tracks filled with virtual metal.

The method may include performing static timing analysis for the first die using the first model of inter-die coupling between the first die and the first virtual die. The method may include, in response to determining that a third die of the circuit design is the same as the first die, using, for the third die, results of the static timing analysis for the first die. Performing static timing analysis for the first die may include, when the layer filled with virtual metal is an aggressor net, treating the layer filled with virtual metal as being connected to a victim net in the first virtual die and disconnected from other nets in the first virtual die.

According to another embodiment, a system includes a memory and a processor communicatively coupled to the memory. The processor receives a circuit design including a first die and a second die positioned on the first die and generates a first virtual interface block including a portion of the first die and a first virtual die positioned on the first die. A layer of the first virtual die closest to the first die includes tracks filled with virtual metal. The processor also performs parasitic extraction based at least in part on the first virtual interface block to generate a first model of inter-die coupling between the first die and the first virtual die.

The processor may generate a second virtual interface block including a portion of the second die and a second virtual die. A layer of the second virtual die closest to the second die may include tracks filled with virtual metal. The processor may perform parasitic extraction based at least in part on the second virtual interface block to generate a second model of inter-die coupling between the second die and the second virtual die. The processor may perform static timing analysis for the second die using the second model of inter-die coupling between the second die and the second virtual die.

The portion of the first die may include a first layer, a second layer positioned on the first layer, and a third layer positioned on the second layer.

Performing parasitic extraction based at least in part on the first virtual interface block may include generating coupling capacitors from the portion of the first die to the tracks filled with virtual metal.

The processor may perform static timing analysis for the first die using the first model of inter-die coupling between the first die and the first virtual die. The processor may, in response to determining that a third die of the circuit design is the same as the first die, use, for the third die, results of the static timing analysis for the first die. Performing static timing analysis for the first die may include, when the layer filled with virtual metal is an aggressor net, treating the layer filled with virtual metal as being connected to a victim net in the first virtual die and disconnected from other nets in the first virtual die.

According to another embodiment, a non-transitory computer readable medium stores instructions that, when executed by a processor, cause the processor to generate a first virtual interface block including a portion of a first die of a plurality of stacked dies and a first virtual die positioned on the first die. A layer of the first virtual die closest to the first die may include tracks filled with virtual metal. The processor may generate a first model of inter-die coupling between the first die and the first virtual die.

The processor may generate a second virtual interface block including a portion of a second die of the plurality of stacked dies and a second virtual die. A layer of the second virtual die closest to the second die may include tracks filled with virtual metal. The processor may generate a second model of inter-die coupling between the second die and the second virtual die. The processor may perform static timing analysis for the second die using the second model of inter-die coupling between the second die and the second virtual die.

Performing parasitic extraction based at least in part on the first virtual interface block may include generating coupling capacitors from the portion of the first die to the tracks filled with virtual metal.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example electric circuit.

FIG. 2 illustrates an example die of the electric circuit of FIG. 1.

FIG. 3 illustrates an example system.

FIG. 4 illustrates an example die and virtual die used in the system of FIG. 3.

FIG. 5 is a flowchart of an example method performed in the system of FIG. 3.

FIG. 6 is a flowchart of an example method performed in the system of FIG. 3.

FIG. 7 depicts a flowchart of various processes used during the design and manufacture of an integrated circuit in accordance with some embodiments of the present disclosure.

FIG. 8 depicts a diagram of an example computer system in which embodiments of the present disclosure may operate.

### DETAILED DESCRIPTION

Aspects of the present disclosure relate to timing analysis in electric circuits with stacked dies. Electric circuit designers perform timing analysis (e.g., static timing analysis) to determine delays in different paths of an electric circuit. The delays may be affected by various factors of the circuit, such as parasitics (e.g., parasitic resistances and parasitic capacitances) present in the circuit.

Timing analysis is very difficult to perform in electric circuits with stacked dies stacked on a common substrate (which may also be referred to as three-dimensional integrated circuits (3DICs)), especially when parasitics between adjacent and/or overlapping dies need to be considered. Because the dies are adjacent to and/or overlapping each other (e.g., stacked on top of each other or positioned next to each other), parasitic capacitances may develop between the dies. This inter-die coupling may affect the delays in the circuit and the timing analysis.

One system may first model the inter-die coupling between the dies and then perform timing analysis using these models. To model the inter-die coupling, the system sets the parasitic corners for the dies and then generates the model for the inter-die coupling using the set parasitic corners. The parasitic corners may be conditions in the dies (e.g., wire thickness, width, inter-metal dielectric, etc.) that result in extreme (e.g., best or worst) behaviors for the dies. For example, the parasitic corners may result in the worst (e.g., highest) parasitic capacitance, the best (e.g., lowest) parasitic capacitance, the worst (e.g., highest) product of parasitic capacitance and resistance, the best (e.g., lowest) product of parasitic capacitance and resistance, etc. The system may then perform timing analysis for that set of parasitic corners using the model.

The system may iterate through and generate models for every combination of parasitic corners for the dies. The systems may also iterate through and perform timing analysis for every model. If one die has M parasitic corners and the other die has N parasitic corners, then the system would iterate through M×N combinations of parasitic corners. Thus, as circuits grow more complex and the number of parasitic corners grows, modeling the inter-die coupling and performing timing analysis becomes a slow and time consuming process. In some instances, the entire device may also have parasitic corners (e.g., K parasitic corners). As a result, the system may iterate through M×N×K combinations of parasitic corners during timing analysis, which further slows timing analysis.

The present disclosure describes a technique for reducing the amount of time it takes to perform timing analysis in electric circuits with stacked dies, in certain embodiments. Generally, the present system and method includes determining the worst case inter-die coupling for a particular die by modeling the inter-die coupling of the die with a virtual die. The virtual die may be a temporary modeled die that is not an actual die in the stack or design. The tracks of a layer of the virtual die closest to the die are filled with virtual metal. As a result, the virtual die is a simulated die, and the simulated die includes a layer (e.g., closest to the die) that includes tracks filled with metal. Thus, modeling the inter-die coupling between the die and the virtual die may produce the worst case inter-die coupling that the die may experience. This process may be repeated for each parasitic corner of the die, and the process may be repeated for every die in the electric circuit. Timing analysis for the die may then be performed using the models.

The present disclosure provides several technical advantages, in certain embodiments. For example, the timing analysis for the dies may be performed more quickly relative to existing techniques. Using the previous example, if one die has M parasitic corners and another die has N parasitic corners, the present technique would iterate through only M+N parasitic corners (e.g., M parasitic corners for the first die and N parasitic corners for the second die) rather than M×N combinations of parasitic corners. Thus, the present system and method may complete the timing analysis for the dies more quickly compared to other techniques. Additionally, the present system and method may allow for parasitic extraction and timing analysis to be performed for individual dies, before other dies in the stack are implemented. Thus, parasitic extraction and timing analysis may be performed separately for separate dies. Moreover, hierarchical flows like interface logic models may work with the present technique.

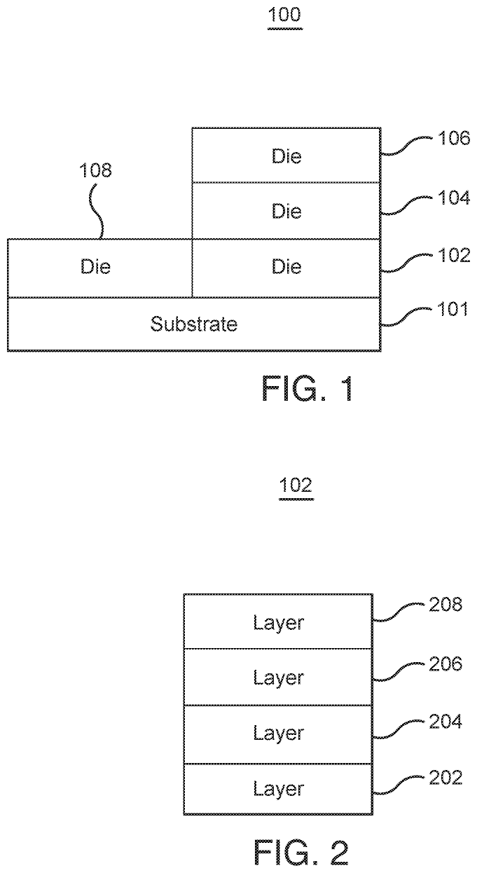

FIG. 1 illustrates an example electric circuit 100. Generally, the electric circuit 100 may be a 3DIC. The electric circuit 100 may include any suitable number of dies. As seen in FIG. 1, the electric circuit 100 includes dies 102, 104, 106, and 108 stacked on a common substrate 101. The dies 102, 104, 106, and 108 may be positioned adjacent to each other. For example, some of the dies 102, 104, and 106 may be stacked on each other, and some of the dies 102 and 108 may be positioned next to each other. The proximity of the dies 102, 104, 106, and 108 to each other may introduce inter-die coupling effects. For example, parasitic capacitances may develop between the dies 102, 104, 106, and 108. These inter-die coupling effects may influence the delays of circuit paths within the dies 102, 104, 106, and 108, which may impact the timing analysis for the dies 102, 104, 106, and 108.

FIG. 2 illustrates an example die 102 of the electric circuit 100 of FIG. 1. The die 102 may include any suitable number of layers in any suitable arrangement. As seen in FIG. 2, the die 102 may include layers 202, 204, 206, and 208. The layers 202, 204, 206, and 208 may be stacked on one another. Thus, when another die (e.g., die 104) is positioned on top of the die 102, the layer 208 may be closest to the other die (e.g., die 104). As another example, when another die is positioned beneath the die 102, the layer 202 may be positioned closest to the other die. As another example, when another die (e.g., die 108) is positioned next to the die 102, each of the layers 202, 204, 206, and 208 may be positioned closest to the other die (e.g., die 108), depending on the number of layers and/or the height of the other die.

Generally, the layers of the die 102 that are close to another die (e.g., a threshold number of layers) are used to model or calculate the inter-die coupling effects between the die 102 and the other die. For example, the process may involve forming a virtual interface block that includes three or more layers of the die 102 that are closest to the other die. The coupling effects of the layers in the virtual interface block with the other die may then be modeled or determined. For example, if another die is positioned on top of the die 102, then the virtual interface block may include the layers 204, 206, and 208. The coupling effects between the layers 204, 206, and 208 and the other die are then modeled or determined. The model for these inter-die coupling effects is then used when performing timing analysis for the die 102.

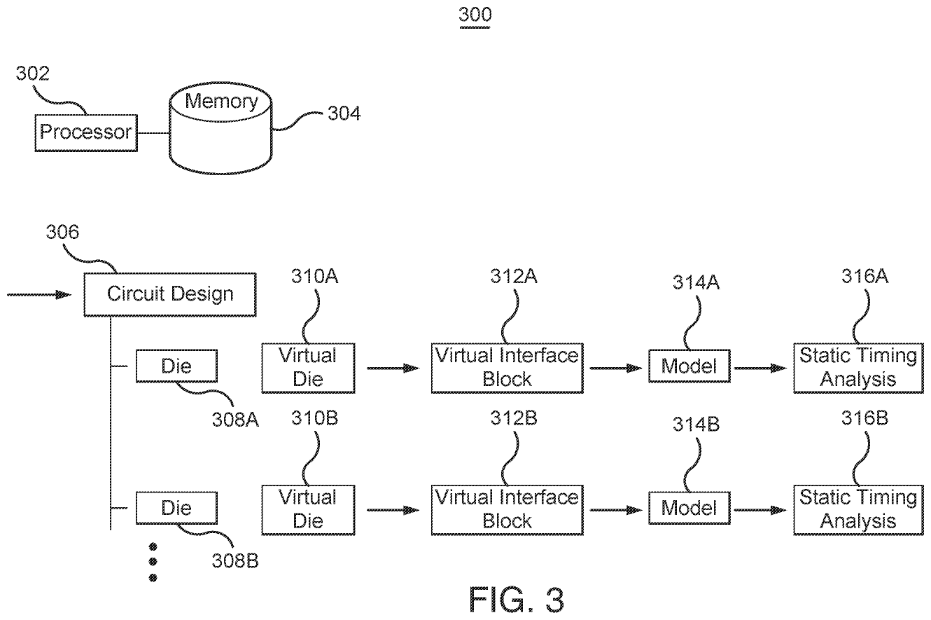

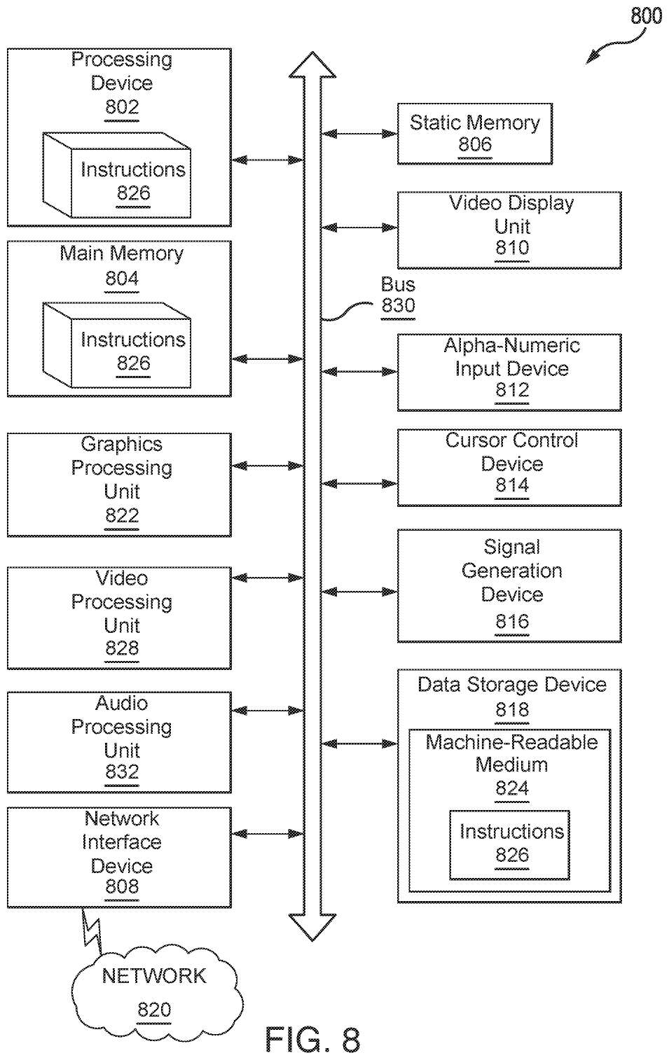

FIG. 3 illustrates an example system 300. Generally, the system 300 may be a computer system (e.g., the computer system 800 shown in FIG. 8). Generally, the system 300 may model the inter-die coupling effects between the dies of a circuit design and a virtual die, whose layers that are closest to the dies is filled with a virtual metal. The models for the inter-die coupling between the dies and the virtual die may present the worst case inter-die coupling for the dies. These models may then be used during the timing analysis for the dies, so that the timing analysis considers the worst case inter-die coupling for each die. As a result of using this technique, the system 300 avoids analyzing every possible combination of parasitic corners between the dies when generating the models, in particular embodiments. As seen in FIG. 3, the system 300 includes a processor 302 and a memory 304, which may perform the actions or functions of the system 300 described herein.

The processor 302 is any electronic circuitry, including, but not limited to one or a combination of microprocessors, microcontrollers, application specific integrated circuits (ASIC), application specific instruction set processor (ASIP), and/or state machines, that communicatively couples to memory 304 and controls the operation of the system 300. The processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 302 may include other hardware that operates software to control and process information. The processor 302 executes software stored on the memory 304 to perform any of the functions described herein. The processor 302 controls the operation and administration of the system 300 by processing information (e.g., information received from the memory 304). The processor 302 is not limited to a single processing device and may encompass multiple processing devices.

The memory 304 may store, either permanently or temporarily, data, operational software, or other information for the processor 302. The memory 304 may include any one or a combination of volatile or non-volatile local or remote devices suitable for storing information. For example, the memory 304 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 304, a disk, a CD, or a flash drive. In particular embodiments, the software may include an application executable by the processor 302 to perform one or more of the functions described herein.

The system 300 receives a circuit design 306. The circuit design 306 may have been communicated to the system 300 by a user using a device. The circuit design 306 may include one or more dies 308. The system 300 may repeat the process described with respect to FIG. 3 to perform timing analysis for each of the dies 308 in the circuit design 306.

As seen in FIG. 3, the circuit design 306 may include a die 308A and a die 308B. The die 308A and the die 308B may be positioned adjacent to each other. For example, the die 308B may be stacked on top of the die 308A, or the die 308B may be positioned next to the die 308A. The system 300 may perform timing analysis for the dies 308A and 308B to determine delays in the circuit paths through the dies 308A and 308B. The system 300 may consider the inter-die coupling effects between the die 308A and 308B when performing the timing analysis. Thus, to perform the timing analysis for the dies 308A and 308B, the system 300 may first model the inter-die coupling effects between the dies 308A and 308B.

The system 300 may perform parasitic extraction to model the inter-die coupling effects of the dies 308A and 308B. Unlike other systems that analyze the inter-die coupling effects between the dies 308A and 308B using different combinations of parasitic corners for the dies 308A and 308B, the system 300 analyzes the inter-die coupling effects between the die 308A and a virtual die 310A and the inter-die coupling effects between the die 308B and a virtual die 310B. The virtual dies 310A and 310B may substitute for the other die (e.g., the die 308B and the die 308A, respectively) in the inter-die coupling effect analysis. For example, if the die 308B is stacked on top of the die 308A, then the virtual die 310A may be stacked on top of the die 308A, and the virtual die 310B may be positioned beneath the die 308B. As another example, if the die 308A is next to the die 308B, then the virtual dies 310A and 310B may be positioned next to the dies 308B and 308A, respectively. Thus, the virtual dies 310A and 310B substitute for the dies 308B and 308A, respectively, in the inter-die coupling effect analysis.

Additionally, the virtual dies 310A and 310B include layers with tracks that are filled with virtual metal. Generally, the layers of the virtual dies 310 that are closest to the die 308 include tracks filled with virtual metal. For example, if the die 308B is stacked on top of the die 308A, then the virtual die 310A is stacked on top of the die 308A during the inter-die coupling effect analysis. The tracks of the bottom layer of the virtual die 310A are filled with virtual metal. Additionally, the virtual die 310B is positioned beneath the die 308B in the inter-die coupling effect analysis. The tracks in the top layer of the virtual die 310B are filled with virtual metal. As a result, the inter-die coupling between the die 308A and the virtual die 310A and the die 308B and the virtual die 310B may present a worst case scenario for inter-die coupling for the dies 308A and 308B.

In some embodiments, the system 300 generates the virtual dies 310A and 310B using information about the dies 308B and 308A, respectively. For example, when generating the virtual die 310A, the system 300 may have information about the structure or design of the die 308B that allows the system 300 to determine a bounding box area for the circuitry or layers in the die 308B. The system 300 then generates the virtual die 310A by simulating the die 308B using the information that the system 300 has about the die 308B. The system 300 then introduces virtual metal fill into the layers of the virtual die 310A closest to the die 308A and within the bounding box. The virtual metal fill insertion may be governed by process technology and may be controlled by a virtual metal fill parameter file, which may set certain parameters that govern the virtual metal fill (e.g., fill spacing, fill width, fill length, etc.). The system 300 may also allow certain areas of the virtual die 310A to be blocked from being filled by virtual metal.

The system 300 generates virtual interface blocks 312 that include portions of the dies 308 and virtual dies 310. In the example of FIG. 3, the system 300 generates the virtual interface blocks 312A and 312B. The virtual interface block 312A may include the layers of the die 308A that are closest to the virtual die 310A (e.g., the top three layers of the die 308A). Additionally, the virtual interface block 312A may include the bottom layers of the virtual die 310A closest to the die 308A (e.g., the bottom three layers of the virtual die 310A), including the bottommost layer whose tracks are filled with virtual metal. The virtual interface block 312A may include any suitable number of layers of the die 308A and any suitable number of layers of the virtual die 310A. The virtual interface block 312B may include the layers of the die 308B that are closest to the virtual die 310B (e.g., the three bottom layers of the die 308B). The virtual interface block 312B may also include the top layers of the virtual die 310B closest to the die 308B (e.g., the three topmost layers of the virtual die 310B), including the topmost layer whose tracks are filled with virtual metal. The virtual interface block 312B may include any suitable number of layers of the die 308B and any suitable number of layers of the virtual die 310B. A user of the system 300 may set the number of layers from the dies 308 and the virtual dies 310 to include the virtual interface blocks 312. During parasitic extraction, to determine or simulate the parasitic capacitance in the virtual interface blocks 312A and 312B, the system 300 may generate coupling capacitors from the layers of the dies 308A and 308B in the virtual interface blocks 312A and 312B to the layers of the virtual dies 310A and 310B with tracks that are filled with virtual metal.

The system 300 performs parasitic extraction and analyzes the inter-die coupling effects in the virtual interface blocks 312A and 312B to produce the models 314A and 314B. The models 314A and 314B model the inter-die coupling effects for the dies 308A and 308B respectively. For example, the model 314A models the inter-die coupling effects between the die 308A and the virtual die 310A. Because the layers of the virtual die 310A closest to the die 308A are filled with virtual metal, the model 314A presents the worst case inter-die coupling that may be experienced by the die 308A. The model 314B models the inter-die coupling effects between the die 308B and the virtual die 310B. Because the layer of the virtual die 310B closest to the die 308B has tracks filled with virtual metal. The model 314B models a worst case inter-die coupling that may be experienced by the die 308B. Thus, the models 314A and 314B bound the inter-die coupling effects that may be experienced by the dies 308A and 308B.

The system 300 may generate a model 314A for the die 308A, and a model 314B for the die 308B for every parasitic corner of the dies 308A and 308B. The system 300 may iterate through the parasitic corners for the dies 308A and 308B and generate a virtual interface block 312A and 312B and a model 314A and 314B for each parasitic corner. Thus, the models 314A and the models 314B model the worst case inter-die coupling effects that may be experienced by the dies 308A and 308B for each parasitic corner of the dies 308A and 308B.

The system 300 may perform static timing analysis 316 using each of the models 314 for the dies 308. In the example of FIG. 3, the system 300 performs static timing analysis 316A using the models 314A for the die 308A. The system 300 may also perform static timing analysis 316B using the models 314B for the die 308B. As a result, the system 300 may iterate through the parasitic corners of the dies 308A and 308B when performing static timing analysis 316A and 316B for the dies 308A and 308B. In this manner, the system 300 determines the worst case timing delays in the circuit paths of the dies 308A and 308B for each parasitic corner of the dies 308A and 308B.

In some embodiments, when the system 300 analyzes the coupling between a net in a die 308 (e.g., a portion of a layer of the die 308 in a virtual interface block 312) and a net in the virtual die 310 filled with virtual metal (e.g., a track in a layer of the virtual die 310 closest to the die 308), the system 300 may treat the net in the virtual die 310 as connected to the net in the die 308 and disconnected from other nets in the die 308. Stated differently, when the net in the virtual die 310 is an aggressor net (e.g., when the net in the virtual die 310 has a coupling capacitance with the net in the die 308 that influences the delay of the net in the die 308) and the net in the die 308 is a victim net (e.g., when the delay of the net in the die 308 is influenced by the coupling capacitance with the net in the virtual die 310), the system 300 treats the aggressor net as being connected to the victim net and to no other nets in the die 308.

In certain embodiments, because the system 300 uses the virtual dies 310A and 310B to model the inter-die coupling effects experienced by the dies 308A and 308B, the system 300 avoids directly analyzing the inter-die coupling effects between the dies 308A and 308B. As a result, the system 300 may not analyze the inter-die coupling effects between the dies 308A and 308B for every combination of the parasitic corners of the dies 308A and 308B. Rather, the system 300 iterates through the parasitic corners of the dies 308A and 308B separately, which reduces the amount of time it takes to perform the timing analysis for the dies 308A and 308B. Using a previous example, if the die 308A has M parasitic corners and the die 308B has N parasitic corners, the system 300 iterates through M+N parasitic corners (e.g., the M parasitic corners for the die 308A and the N parasitic corners for the die 308B) rather than analyzing M×N combinations of parasitic corners, which reduces the amount of time it takes to perform the timing analysis for the dies 308A and 308B.

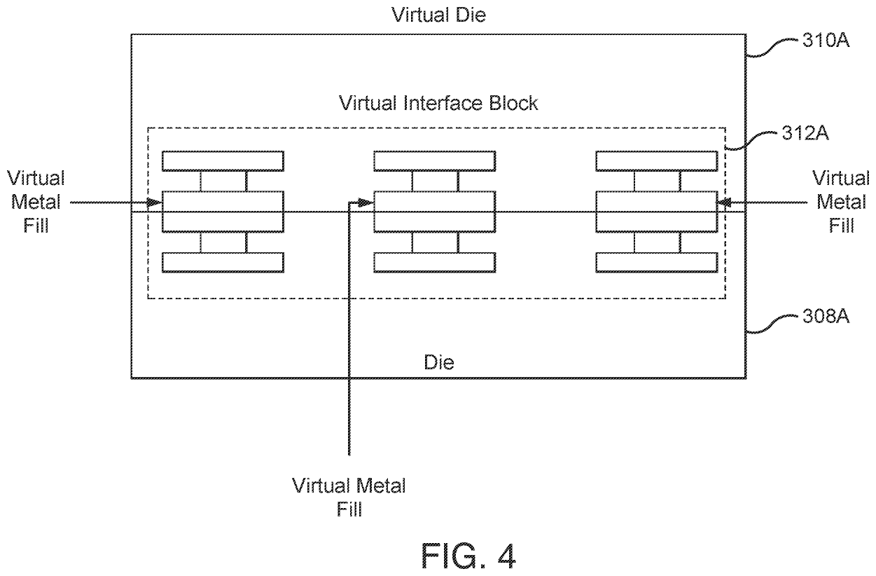

FIG. 4 illustrates an example die 308A and virtual die 310A used in the system 300 of FIG. 3. As seen in FIG. 4, the virtual die 310A is positioned on top of the die 308A. Additionally, the virtual interface block 312A is formed to encompass the layers of the die 308A and the layers of the virtual die 310A that are closest to each other. For example, the virtual interface block 312A may include the top three layers of the die 308A and the bottom three layers of the virtual die 310A. Notably, the bottom layer of the virtual die 310A includes tracks that are filled with virtual metal. As a result, the inter-die coupling effects presented in the virtual interface block 312A bound the inter-die coupling effects experience by the die 308A. Thus, analyzing the inter-die coupling effects presented by the virtual interface block 312A may result in a model that models the worst case inter-die coupling experienced by the die 308A.

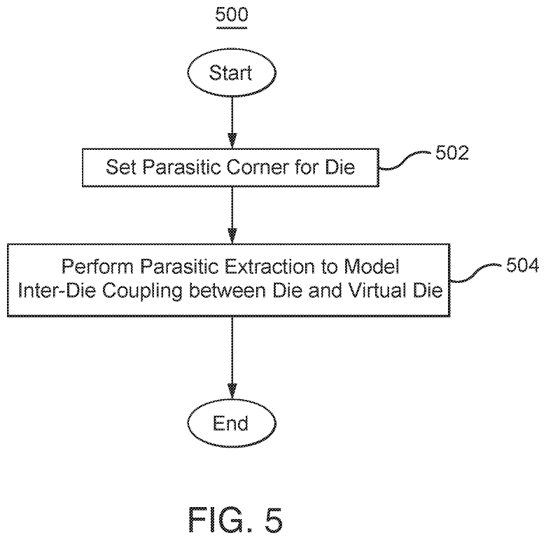

FIG. 5 is a flowchart of an example method 500 performed in the system 300 of FIG. 3. In particular embodiments, the system 300, which may be a computer system (e.g., the computer system 800 of FIG. 8), performs the method 500. By performing the method 500 the system 300 generates a model 314 that models inter-die coupling effects experienced by a die 308.

At 502, the computer system sets a parasitic corner for a die 308A. The die 308A may have several parasitic corners. The computer system may select one of the parasitic corners for one iteration of the method 500. The computer system may perform multiple iterations of the method 500 to iterate through every parasitic corner of the die 308A. The parasitic corner may indicate conditions in the die 308A (e.g., wire thickness, width, inter-metal dielectrics, etc.) that result in extreme (e.g., best or worst) behaviors for the die 308. For example, the parasitic corner may result in the worst (e.g., highest) parasitic capacitance, the best (e.g., lowest) parasitic capacitance, the worst (e.g., highest) product of parasitic capacitance and resistance, or the best (e.g., lowest) product of parasitic capacitance and resistance.

At 504, the computer system performs parasitic extraction to model inter-die coupling effects between the die 308A and a virtual die 310A based on the selected parasitic corner for the die 308A. The virtual die 310A may substitute for another die 308B in the arrangement of the dies 308A and 308B in a circuit design 306. For example, if the die 308B is stacked on top of the die 308A, then the virtual die 310A may also be stacked on top of the die 308A. The layer of the virtual die 310A that is closest to the die 308A may also include tracks that are filled with virtual metal. Thus, if the virtual die 310A is stacked on top of the die 308A, then the bottom layer of the virtual die 310A includes tracks that are filled with virtual metal. As a result, the inter-die coupling between the die 308A and the virtual die 310A may bound the inter-die coupling effects experienced by the die 308A.

The computer system may generate a virtual interface block 312A that includes portions of the die 308A and portions of the virtual die 310A. For example, the virtual interface block 312A may include the top three layers of the die 308A and the bottom three layers of the virtual die 310A, including the layer of the virtual die 310A with tracks that are filled with virtual metal. The computer system then analyzes the inter-die coupling effects in the virtual interface block 312A to produce a model 314A that models the inter-die coupling effects in the virtual interface block 312A. The model 314A may model the worst case inter-die coupling effects experienced by the die 308A.

As discussed above, the computer system may perform multiple iterations of the method 500 to generate a model 314A for every parasitic corner of the die 308A. Thus, the computer system may perform an iteration of the method 500 for each parasitic corner of the die 308A, and the computer system may generate a model 314A for each parasitic corner of the die 308A.

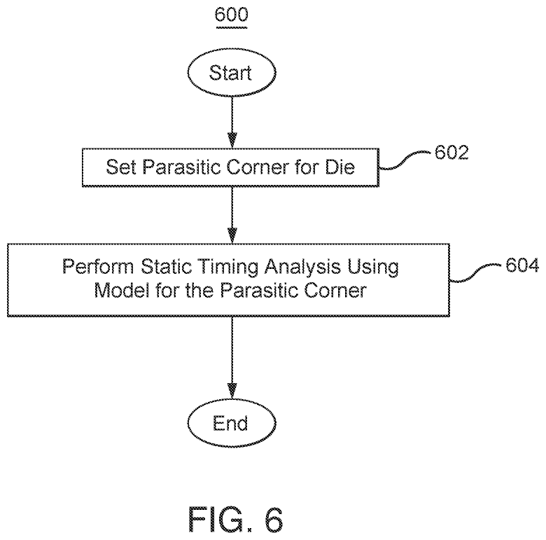

FIG. 6 is a flowchart of an example method 600 performed in the system 300 of FIG. 3. In particular embodiments, the system 300, which may be a computer system (e.g., the computer system 800 shown in FIG. 8), performs the method 600. By performing the method 600, the computer system determines timing delays in a die 308A of a circuit design 306.

At 602, the computer system sets a parasitic corner for the die 308A. The die 308A may have several parasitic corners. The computer system may perform multiple iterations of the method at 600 to perform timing analysis for every parasitic corner of the die 308A.

At 604, the computer system performs static timing analysis 316A using the model 314A (obtained from 504) for the parasitic corner that was set at 602. During the static timing analysis 316A, the computer system may consider the delays through the die 308A while taking into account the inter-die coupling effects experienced by the die 308A as modeled by the model 314A. As a result, the computer system may not consider the inter-die coupling effects between the die 308A and the die 308B when performing the static timing analysis 316A.

The computer system may repeat the method 600 to perform static timing analysis 316A for other parasitic corners of the die 308A. In this manner, the computer system determines timing delays through the die 308A with different parasitic corners set for the die 308A. The computer system may then analyze the different timing delays through the die 308A to determine if adjustments should be made to the die 308A to improve timing delays.

In some embodiments, the computer system may reuse the timing analysis for a die 308 if another die 308 in the circuit design 306 is the same. For example, if the computer system determines that the circuit design includes another die 308 that is the same as the die 308A, then the computer system may reuse the timing analysis for the die 308A when analyzing the other die 308. In this manner, the computer system may avoid performing the methods 500 and 600 for the other die 308, which reduces the time it takes to perform timing analysis for the circuit design 306.

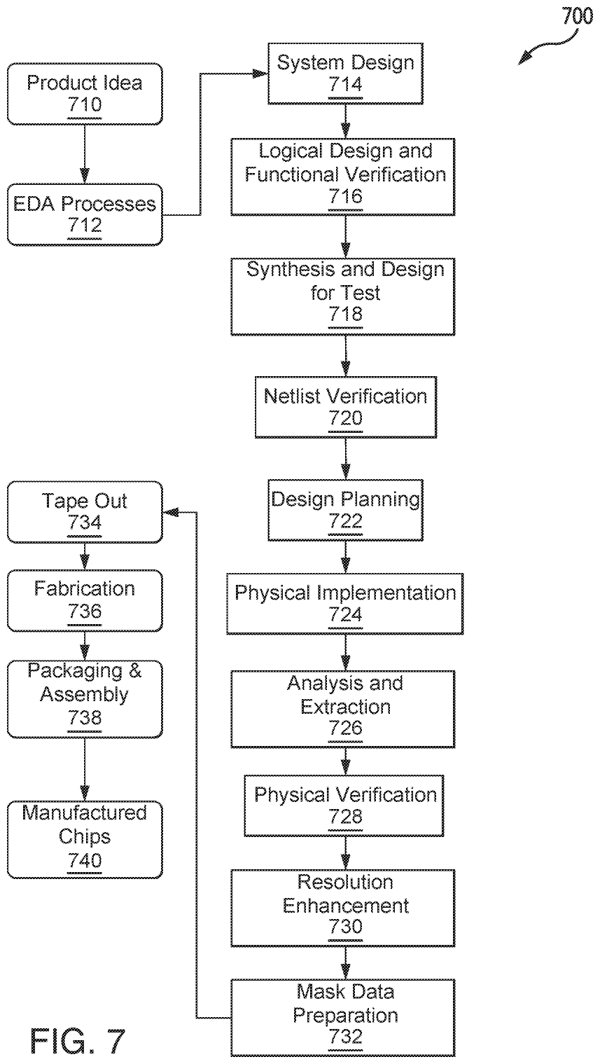

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 7. The processes described by be enabled by EDA products (or EDA systems).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

A storage subsystem of a computer system (such as computer system 800 of FIG. 8) may be used to store the programs and data structures that are used by some or all of the EDA products described herein, and products used for development of cells for the library and for physical and logical design that use the library.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving a circuit design comprising a first die and a second die positioned on the first die;
generating, by a processing device, a first virtual interface block comprising a portion of the first die and a first virtual die positioned adjacent to the first die, wherein a layer of the first virtual die closest to the first die comprises first tracks filled with virtual metal; and
performing parasitic extraction based at least in part on the first virtual interface block to generate a first model of inter-die coupling between the first die and the first virtual die.

2. The method of claim 1, further comprising:
generating a second virtual interface block comprising a portion of the second die and a second virtual die, wherein a layer of the second virtual die closest to the second die comprises second tracks filled with virtual metal; and
performing parasitic extraction based at least in part on the second virtual interface block to generate a second model of inter-die coupling between the second die and the second virtual die.

3. The method of claim 2, further comprising, performing static timing analysis for the second die using the second model of inter-die coupling between the second die and the second virtual die.

4. The method of claim 1, wherein the portion of the first die comprises one or more of a first layer, a second layer positioned on the first layer, and a third layer positioned on the second layer.

5. The method of claim 1, wherein performing parasitic extraction based at least in part on the first virtual interface block comprises generating coupling capacitors from the portion of the first die to the first tracks filled with virtual metal.

6. The method of claim 1, further comprising performing static timing analysis for the first die using the first model of inter-die coupling between the first die and the first virtual die.

7. The method of claim 6, further comprising, in response to determining that a third die of the circuit design is the same as the first die, using, for the third die, results of the static timing analysis for the first die.

8. The method of claim 6, wherein performing static timing analysis for the first die comprises, when the layer filled with virtual metal is an aggressor net, treating the layer filled with virtual metal as being connected to a victim net in the first virtual die and disconnected from other nets in the first virtual die.

9. A system comprising:
a memory; and
a processor communicatively coupled to the memory, the processor configured to:
receive a circuit design comprising a first die and a second die positioned on the first die;
generate a first virtual interface block comprising a portion of the first die and a first virtual die positioned on the first die, wherein a layer of the first virtual die closest to the first die comprises tracks filled with virtual metal; and
perform parasitic extraction based at least in part on the first virtual interface block to generate a first model of inter-die coupling between the first die and the first virtual die.

10. The system of claim 9, wherein the processor is further configured to:
generate a second virtual interface block comprising a portion of the second die and a second virtual die, wherein a layer of the second virtual die closest to the second die comprises tracks filled with virtual metal; and
perform parasitic extraction based at least in part on the second virtual interface block to generate a second model of inter-die coupling between the second die and the second virtual die.

11. The system of claim 10, wherein the processor is further configured to perform static timing analysis for the second die using the second model of inter-die coupling between the second die and the second virtual die.

12. The system of claim 9, wherein the portion of the first die comprises a first layer, a second layer positioned on the first layer, and a third layer positioned on the second layer.

13. The system of claim 9, wherein performing parasitic extraction based at least in part on the first virtual interface block comprises generating coupling capacitors from the portion of the first die to the tracks filled with virtual metal.

14. The system of claim 9, wherein the processor is further configured to perform static timing analysis for the first die using the first model of inter-die coupling between the first die and the first virtual die.

15. The system of claim 14, wherein the processor is further configured to, in response to determining that a third die of the circuit design is the same as the first die, use, for the third die, results of the static timing analysis for the first die.

16. The system of claim 14, wherein performing static timing analysis for the first die comprises, when the layer filled with virtual metal is an aggressor net, treating the layer filled with virtual metal as being connected to a victim net in the first virtual die and disconnected from other nets in the first virtual die.

17. A non-transitory computer readable medium storing instructions that, when executed by a processor, cause the processor to:
generate a first virtual interface block comprising a portion of a first die of a plurality of stacked dies and a first virtual die positioned on the first die, wherein a layer of the first virtual die closest to the first die comprises tracks filled with virtual metal; and
generate a first model of inter-die coupling between the first die and the first virtual die.

18. The computer readable medium of claim 17, wherein the processor further:
generates a second virtual interface block comprising a portion of a second die of the plurality of stacked dies and a second virtual die, wherein a layer of the second virtual die closest to the second die comprises tracks filled with virtual metal; and
generates a second model of inter-die coupling between the second die and the second virtual die.

19. The computer readable medium of claim 18, wherein the processor further performs static timing analysis for the second die using the second model of inter-die coupling between the second die and the second virtual die.

20. The computer readable medium of claim 17, wherein performing parasitic extraction based at least in part on the first virtual interface block comprises generating coupling capacitors from the portion of the first die to the tracks filled with virtual metal.
